(19) United States
(12) Patent Application Publication
(10) Pub. No.: US 2025/0391883 A1
(43) Pub. Date: Dec. 25, 2025

(54) CURRENT COLLECTOR FOR BIPOLAR BATTERY, AND BIPOLAR BATTERY

(71) Applicant: TOYOTA JIDOSHA KABUSHIKI KAISHA, Toyota-shi (JP)

(72) Inventors: Yusuke KINTSU, Miyoshi-shi (JP); Takahiko Nakano, Nagoya-shi (JP); Hirokazu Takeuchi, Toyota-shi (JP); Shinji Kojima, Nagoya-shi (JP)

(73) Assignee: TOYOTA JIDOSHA KABUSHIKI KAISHA, Toyota-shi (JP)

(21) Appl. No.: 19/047,063

(22) Filed: Feb. 6, 2025

(30) Foreign Application Priority Data
Jun. 21, 2024 (JP) 2024-100645

(51) Int. Cl. H01M 4/66; H01M 4/02

(52) U.S. Cl. CPC H01M 4/667; H01M 2004/029

(57) ABSTRACT

In the current collector for a bipolar battery of the present disclosure, the first current collector and the second current collector are bonded to each other via a conductive adhesive layer, and the first current collector and the second current collector have a weld portion and are welded to each other over a peripheral portion of the current collector for a bipolar battery, whereby the conductive adhesive layer is sealed. The bipolar battery of the present disclosure includes an anode active material layer, a current collector for a bipolar battery of the present disclosure, and a cathode active material layer in this order.

### CROSS-REFERENCE TO RELATED APPLICATION

This application claims priority to Japanese Patent Application No. 2024-100645 filed on Jun. 21, 2024. The disclosure of the above-identified application, including the specification, drawings, and claims, is incorporated by reference herein in its entirety.

### BACKGROUND

### 1. Technical Field

The present disclosure relates to a current collector for a bipolar battery, and a bipolar battery.

### 2. Description of Related Art

Current collectors for bipolar batteries are known, such as disclosed in Japanese Unexamined Patent Application Publication No. 2022-075283 (JP 2022-075283 A), WO 2023/218864, WO 2024/053312, Japanese Unexamined Patent Application Publication No. 2023-092421 (JP 2023-092421 A), and Japanese Unexamined Patent Application Publication No. 2023-110291 (JP 2023-110291 A). In current collectors for bipolar batteries, a cathode active material layer is formed on one face, and an anode active material layer is formed on the other face.

### SUMMARY

A current collector for a bipolar battery may be made up of a first current collector and a second current collector that are bonded to each other via a conductive adhesive layer. There is room for improvement in batteries using such a current collector for a bipolar battery, in terms of battery performance.

An object of the present disclosure is to provide a current collector for a bipolar battery that is capable of improving battery performance, and a bipolar battery having such a current collector for a bipolar battery.

The present disclosers found that the above issue can be solved by the following means.

### First Aspect

A current collector for a bipolar battery, in which
a first current collector and a second current collector are bonded to each other via a conductive adhesive layer, and
a weld portion, in which the first current collector and the second current collector are welded to each other, is provided over a peripheral portion of the current collector for a bipolar battery, by which the conductive adhesive layer is sealed.

### Second Aspect

The current collector according to the First Aspect, in which the conductive adhesive layer includes a water-based adhesive.

### Third Aspect

The current collector according to the First or Second Aspects, in which a width of the weld portion is no less than 1 mm and no more than 10 mm.

### Fourth Aspect

The current collector according to any one of the First to Third Aspects, further including a sealing member that seals the weld portion.

### Fifth Aspect

A bipolar battery, including an anode active material layer, the current collector according to any one of the First to Fourth Aspects, and a cathode active material layer, that are provided in an order of the anode active material layer, the current collector, and the cathode active material layer.

According to the present disclosure, a current collector for a bipolar battery that is capable of improving battery performance, and a bipolar battery having such a current collector for a bipolar battery, can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view showing an example of a current collector for a bipolar battery of the present disclosure;

FIG. 2 is a schematic cross-sectional view illustrating an example of a current collector for a bipolar battery of the present disclosure;

FIG. 3 is a schematic cross-sectional view illustrating an exemplary bipolar battery of the present disclosure; and

FIG. 4 is a schematic cross-sectional view showing an example of a current collector for a bipolar battery according to the prior art.

### DETAILED DESCRIPTION OF EMBODIMENTS

Hereinafter, embodiments of the present disclosure will be described in detail. It should be noted that the present disclosure is not limited to the following embodiments, and various modifications can be made within the scope of the gist of the disclosure.

### Current Collector for Bipolar Battery

In the current collector for a bipolar battery of the present disclosure, the first current collector and the second current collector are bonded to each other via a conductive adhesive layer. A first current collector and a second current collector have a weld portion and are welded to each other over a peripheral portion of the current collector for a bipolar battery, whereby the conductive adhesive layer is sealed.

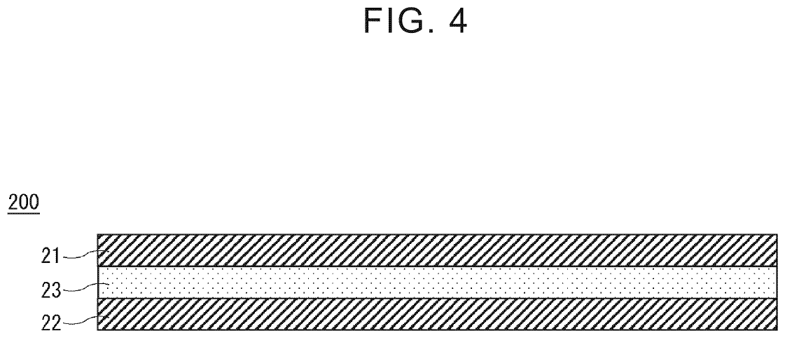

The inventors of the present disclosure considered that, in a bipolar battery having a current collector for a bipolar battery composed of a first current collector and a second current collector adhered to each other via a conductive adhesive layer, one of the causes of deterioration in battery performance is the moisture contained in the conductive adhesive layer. Specifically, although this is not intended to be bound by any theory, it is presumed as follows. That is, in the current collector 200 for a bipolar battery according to the related art as illustrated in FIG. 4, moisture in the conductive adhesive layer 23 remaining even after the manufacturing process is gradually released from the end portion of the conductive adhesive layer 23. As a result, the battery performance was considered to be deteriorated.

In this regard, the inventors of the present disclosure have a welded portion in which the first current collector and the second current collector are welded to each other over a peripheral portion of the current collector for a bipolar battery. The conductive adhesive layer is thereby sealed. As a result, it is possible to prevent moisture in the conductive adhesive layer remaining even after the manufacturing process from being released from the end portion of the conductive adhesive layer. As a result, it was found that the battery performance can be improved.

Hereinafter, elements constituting the current collector for a bipolar battery of the present disclosure will be described with reference to the drawings. The dimensional relationship in the drawings does not reflect the actual dimensional relationship.

### First Current Collector and Second Current Collector

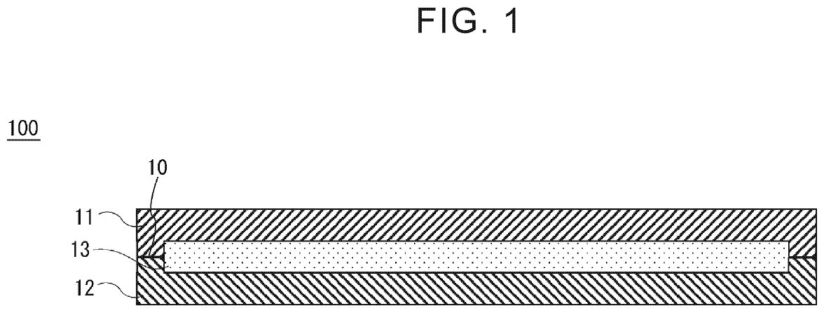

As illustrated in FIG. 1, in the current collector 100 for a bipolar battery of the present disclosure, the first current collector 11 and the second current collector 12 are bonded to each other via the conductive adhesive layer 13, and thereby function as a current collector for a bipolar battery.

The first and second current collectors are not particularly limited. For example, when the battery using the current collector for a bipolar battery of the present disclosure is a lithium ion secondary battery, the first and second current collectors may be copper foil, copper alloy foil, nickel foil, aluminum foil, aluminum alloy foil, stainless steel foil, carbon sheet, or the like. In particular, the first current collector and the second current collector may be different. That is, for example, the anode active material layer and the cathode active material layer are respectively disposed on the surface of the first current collector and the second current collector on the side opposite to the surface to be bonded by the conductive adhesive layer. In this case, the first current collector may be a copper foil and the second current collector may be an aluminum foil.

The thickness of the first and second current collectors is not particularly limited as long as the first and second current collectors can be welded to each other.

The shape and size of the first and second current collectors are not particularly limited as long as a welded portion to be described later can be formed over the peripheral portion of the current collector for a bipolar battery.

### Conductive Adhesive Layer

As illustrated in FIG. 1, the conductive adhesive layer 13 is interposed between the first current collector 11 and the second current collector 12 to adhere the first current collector 11 and the second current collector 12. The first and second current collectors bonded in this manner function as current collectors for bipolar batteries.

The material of the conductive adhesive layer is not particularly limited. The electrically conductive adhesive layer may comprise an electrically conductive adhesive, i.e., for example, a mixture of an adhesive and an electrically conductive component.

The adhesive may comprise a curable resin. Examples of the curable resin include a thermosetting resin and a photocurable resin. More specifically, examples of the curable resin include an olefinic resin and an acrylic resin.

The conductive adhesive layer 13 may include a water-based adhesive as an adhesive. When the adhesive in the conductive adhesive layer 13 is a water-based adhesive, moisture tends to remain in the conductive adhesive layer after the manufacturing process, and therefore, the advantage of applying the adhesive to the current collector for a bipolar battery of the present disclosure is greater. Examples of the water-based adhesive include, but are not limited to, water-based curable resins. Examples of the aqueous curable resin include an aqueous dispersion olefin resin.

The conductive component is not particularly limited as long as it has higher conductivity than the adhesive. Examples of the conductive component include metal particles such as gold, silver, platinum, zinc, stainless steel, nickel, copper, cobalt, molybdenum, antimony, iron, and chromium; alloy particles such as aluminum-magnesium alloys, and aluminum-nickel alloys, and so forth, metal oxide particles such as tin oxide and indium oxide; particles obtained by coating noble metals such as gold, silver, and platinum on metal particles such as nickel; particles obtained by coating noble metals such as gold, silver, and platinum on non-conductive particles such as glass, ceramic, and plastic particles, or particles obtained by coating metals such as nickel on non-conductive particles such as plastic particles; carbon particles like graphites such as natural graphite and artificial graphite, and carbon blacks such as acetylene black, Ketjen black, channel black, furnace black, lamp black, and thermal black.

The thickness of the conductive adhesive layer is not particularly limited.

The size of the conductive adhesive layer is not particularly limited as long as it is smaller than that of the first and second current collectors to the extent that a welded portion to be described later can be formed.

### Weld Portion

As illustrated in FIG. 1, a current collector 100 for a bipolar battery of the present disclosure includes a welded portion 10 in which a first current collector 11 and a second current collector 12 are welded to each other over a peripheral portion of a current collector 100 for a bipolar battery. The conductive adhesive layer 13 is thereby sealed. In the context of the present disclosure, the term “peripheral portion of the current collector for a bipolar battery” may in particular mean a portion of the first and second current collectors extending from the conductive adhesive layer.

The weld portion may be 1 mm or more and 10 mm or less wide. The welded portion may be 1 mm or more, 3 mm or more, 4 mm or more, or 5 mm or more, and may be 10 mm or less, 8 mm or less, 6 mm or less. When the width of the welded portion is within the above range, the welded portion can be formed without impairing the volume efficiency of the battery. In the context of the present disclosure, “width of weld portion” may refer to the shortest length from the inside to the outside of a current collector for a bipolar battery.

A method of forming the welded portion is not particularly limited, and a conventionally known welding method can be employed. Examples of such a welding method include ultrasonic welding.

The method of manufacturing the current collector for a bipolar battery of the present disclosure is not particularly limited. The current collector for a bipolar battery of the present disclosure can be manufactured, for example, by the following method:

First, the first current collector and the second current collector are bonded to each other with a conductive adhesive using a dry laminator. Thereafter, the first current collector and the second current collector are ultrasonically welded to each other over a peripheral portion of the current collector for a bipolar battery.

### Seal Member

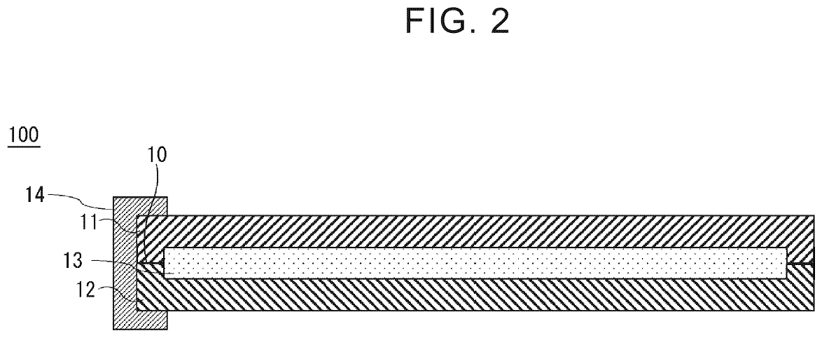

As illustrated in FIG. 2, the current collector 100 for a bipolar battery of the present disclosure may further include a seal member 14 that seals the welded portion 10. With such a configuration, for example, in a case where the conductive adhesive layer 13 is not properly sealed by the welded portion 10, it is possible to suppress the release of moisture in the conductive adhesive layer 13 by the seal member 14.

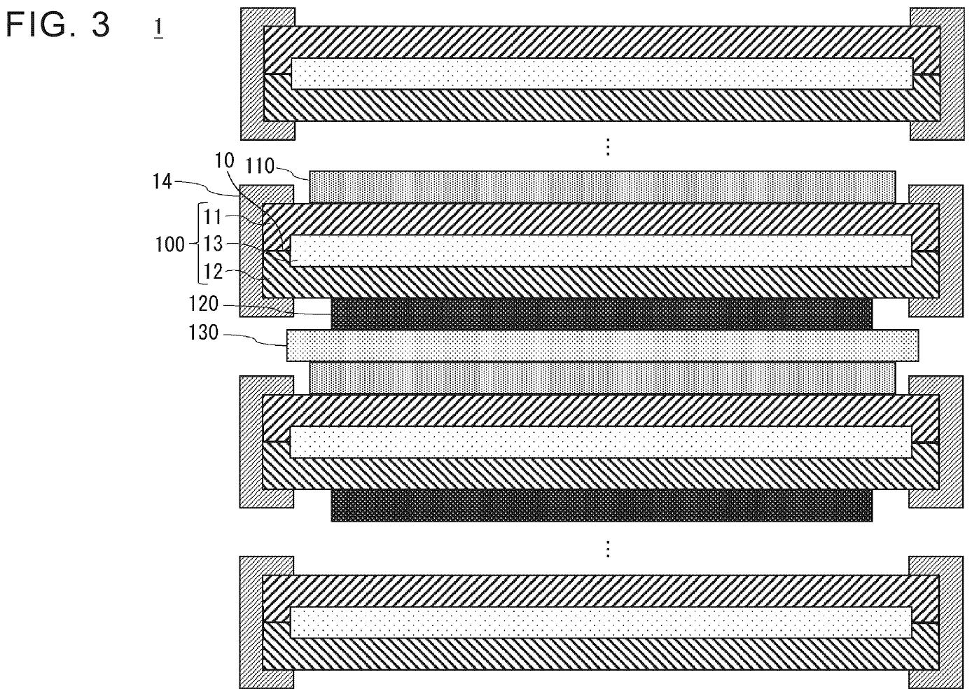

Although FIG. 2 illustrates an embodiment in which the seal member 14 is formed only at one end of the current collector 100 for a bipolar battery, in particular, a seal member may be formed at both ends of the bipolar battery current collector as illustrated in FIG. 3, which illustrates an example of the bipolar battery of the present disclosure described later.

The shape of the seal member is not particularly limited. For example, as illustrated in FIG. 2, the current collector 100 for a bipolar battery may be shaped to cover a side surface and a part of a surface. Further, for example, in FIG. 3, a mode in which a plurality of seal members are separated from each other in the lamination direction is illustrated, but in the bipolar battery of the present disclosure, the seal members may be connected to each other in the lamination direction.

The material of the seal member is not particularly limited, but may be, for example, a resin. Examples of the resin include thermoplastic resins. When the material of the sealing member is a thermoplastic resin, the sealing member can be formed by welding the thermoplastic resin to the current collector for a bipolar battery. Examples of the thermoplastic resin include acid-modified polyethylene, acid-modified polypropylene, polyethylene, and polypropylene.

### Bipolar Battery

The bipolar battery of the present disclosure includes an anode active material layer, a current collector for a bipolar battery of the present disclosure, and a cathode active material layer in this order.

In the bipolar battery of the present disclosure, the first current collector and the second current collector have a weld portion and are welded to each other over a peripheral portion of the current collector for a bipolar battery, whereby the conductive adhesive layer is sealed. Accordingly, in the bipolar battery of the present disclosure, it is possible to prevent moisture from being released from the end portion of the conductive adhesive layer, and as a result, it is possible to improve the battery performance.

In the present disclosure, the first electrode active material layer, the current collector for a bipolar battery of the present disclosure, and the laminate composed of the second electrode active material layer may be referred to as a “bipolar electrode laminate”.

The bipolar battery of the present disclosure may further include an electrolyte layer in addition to the bipolar electrode stack.

As illustrated in FIG. 3, the bipolar battery 1 of the present disclosure may be configured by stacking a plurality of bipolar electrode stacks and an electrolyte layer 130. The number of the bipolar electrode stack and the electrolyte layer is not particularly limited.

The bipolar battery of the present disclosure may be a secondary battery, particularly a lithium-ion secondary battery.

The bipolar battery of the present disclosure may be a liquid-based battery or a solid-state battery. In the context of the present disclosure, a “solid battery” means a battery using at least a solid electrolyte as an electrolyte, and therefore a solid battery may use a combination of a solid electrolyte and a liquid electrolyte as an electrolyte. The solid-state battery of the present disclosure may be an all-solid-state battery, that is, a battery using only a solid electrolyte as an electrolyte.

Hereinafter, elements constituting the bipolar battery of the present disclosure will be described.

### Anode Active Material Layer and Cathode Active Material Layer

In the bipolar battery 1 of the present disclosure, the anode active material layer 110, the current collector 100 for a bipolar battery of the present disclosure, and the cathode active material layer 120 are arranged in this order. As illustrated in FIG. 3, the anode active material layer 110 may be disposed on the first current collector 11 side of the current collector 100 for a bipolar battery, and the cathode active material layer 120 may be disposed on the second current collector 12 side of the current collector 100 for a bipolar battery.

The anode active material layer includes an anode active material, and may optionally be formed of an anode mixture including a conductive auxiliary agent, a binder, and the like, and the cathode active material layer includes a cathode active material, and may optionally be formed of a cathode mixture including a conductive auxiliary agent, a binder, and the like.

In the context of the present disclosure, “mixture” means a composition that can constitute an electrode active material layer, either as it is or by further containing other components. Also, in the context of the present disclosure, a “mixture slurry” means a slurry that includes a dispersion medium in addition to a “mixture” and can be applied and dried to form an electrode active material layer.

### Anode Active Material

The anode active material is not particularly limited as long as it has a lower potential than that of the cathode active material. When the bipolar battery of the present disclosure is a lithium ion secondary battery, the anode active material includes the following examples. For example, carbonaceous materials such as graphite, resinous coal, carbon fiber, activated carbon, carbon soft carbon and so forth; metal-based materials of which tin, tin alloy, silicon, silicon alloy, gallium, gallium alloy, indium, indium alloy, aluminum, aluminum alloy, or the like is a primary component; conductive polymers such as polyacene, polyacetylene, polypyrrole; metal lithium; lithium titanium complex oxides such as Li₄Ti₅O₁₂, lithium alloys such as Li—Si alloy, Li—Sn alloy, Li—Al alloy, Li—Ga alloy, Li—Mg alloy, and Li—In alloy. These anode active materials may be used in one type alone or a combination of two or more types.

The content of the anode active material in the anode gating material may be more than 50% by mass, more than 70% by mass, more than 90% by mass, or more than 95% by mass.

The shape of the anode active material may be, for example, particulate.

### Cathode Active Material

The cathode active material is not particularly limited as long as it has a noble potential as compared with the anode active material. When the bipolar battery of the present disclosure is a lithium ion secondary battery, the following examples can be used as the cathode active material. For example, complex oxides such as lithium cobaltate (LiCoO₂), lithium nickelate (LiNiO₂), lithium manganate (LiMn₂O₄), solid solution oxide (Li₂MnO₃-LiMO₂ (M=Co, Ni, etc.)), nickel lithium manganate (LiNi_{1/2}Mn_{1/2}O₂), nickel lithium cobalt manganate (LiNi_{1/3}Mn_{1/3}Co_{1/3}O₂), and olivine-type lithium phosphate (LiFePO₄); conductive polymers such as polyaniline, polypyrrole; sulfide-based cathode active materials such as Li₂S, CuS, Li—Cu—S compounds, TiS₂, FeS, MoS₂, Li—Mo—S compounds, Li—Ti—S compounds, and Li—V—S compounds; and materials using sulfur as active material such as acetylene black impregnated with sulfur, porous carbon impregnated with sulfur, and a mixed powder of sulfur and carbon are used as the active material. These cathode active materials may be used singly or in a combination of two or more.

The content of the cathode active material in the cathode gating material may be more than 50% by mass, 70% by mass, more than 90% by mass, or more than 95% by mass.

The shape of the cathode active material may be, for example, particulate.

### Conductive Aid

The conductive auxiliary agent is not particularly limited, but the bipolar battery of the present disclosure is a lithium ion secondary battery. In this case, examples include graphites such as natural graphite and artificial graphite; carbon blacks such as acetylene black, Ketjen black, channel black, furnace black, lamp black, and thermal black; conductive fibers such as carbon fibers like carbon nanotubes, metal fibers, and so forth; metal powders such as aluminum powder; conductive whiskers such as zinc oxide whiskers and conductive potassium titanate whiskers; conductive metal oxides such as titanium oxide; organic conductive materials such as phenylene derivatives; and the like. These conduction aids may be used in one single type or a combination of two or more types.

The content of the conductive auxiliary agent in the anode mixture and the cathode mixture is not particularly limited, and can be appropriately set in accordance with desired conductivity or the like.

### Binder

The binder is not particularly limited, but the bipolar battery of the present disclosure is a lithium ion secondary battery. Examples thereof include polyvinylidene fluoride (PVdF), polytetrafluoroethylene, polyethylene, polypropylene, aramid resin, polyamide, polyimide, polyamideimide, polyvinyl alcohol, polyacrylonitrile, polyacrylic acid, methyl polyacrylate, ethyl polyacrylate, hexyl polyacrylate, polymethacrylic acid, methyl polymethacrylate, ethyl polymethacrylate, hexyl polymethacrylate, polyvinyl acetate, polyvinyl pyrrolidone, polyether, polyether sulfone, polyhexafluoropropylene, styrene butadiene rubber, carboxymethyl cellulose, and so forth. These binders may be used singly or in a combination of two or more.

The content of the conductive auxiliary agent in the anode mixture and the cathode mixture is not particularly limited, and can be appropriately set according to a desired binding property or the like.

In the context of the present disclosure, the bipolar electrode stack can be produced, for example, by the following method:
An anode (or cathode) mixture slurry is prepared by adding a solvent to an anode (or cathode) mixture, and the slurry is applied to one side of a current collector for a bipolar battery using an applicator or the like and dried to form an anode (or cathode) active material layer;
A cathode (or anode) mixture slurry is prepared by adding a solvent to a cathode (or anode) mixture, and the slurry is applied to the other side of the current collector for a bipolar battery using an applicator or the like and dried to form a cathode (or anode) active material layer to obtain a laminate;
The resulting laminate is pressurized by roll pressing or the like while applying a predetermined load.

### Electrolyte Layer

The electrolyte layer 130 may be disposed between the anode active material layer 110 and the cathode active material layer 120.

The electrolyte layer may be a porous separator impregnated with a non-aqueous electrolyte solution, a solid electrolyte layer including a solid electrolyte, or a combination thereof.

The porous separator is not particularly limited as long as it has a function of electrically insulating the anode active material layer and the cathode active material layer and transmitting lithium ions when the bipolar battery of the present disclosure is a lithium ion secondary battery. As the porous separator, for example, a porous membrane can be used. Examples of the porous film include a microporous polymer film, and examples of the material include polyolefin, polyimide, polyvinylidene fluoride, and polyester.

The non-aqueous electrolyte solution is a solution obtained by dissolving an electrolyte in a solvent. As the electrolyte, any known lithium salt can be used, and may be selected according to the type of the active material. For example, LiClO₄, LiBF₄, LiPF₆, LiCF₃SO₃, LiCF₃CO₂, LiAsF₆, LiSbF₆, LiB₁₀Cl₁₀, LiAlCl₄, LiCl, LiBr, LiB(C₂H₅)₄, CF₃SO₃Li, CH₃SO₃Li, LiCF₃SO₃, LiC₄F₉SO₃, Li(CF₃SO₂)₂N, lithium lower fatty acid carboxylate, and the like.

The solvent for dissolving the electrolyte is not particularly limited as long as it is usually used as a liquid for dissolving the electrolyte. Examples thereof include carbonates such as ethylene carbonate (EC), propylene carbonate (PC), butylene carbonate (BC), dimethyl carbonate (DMC), diethyl carbonate (DEC), methyl ethyl carbonate (MEC), and vinylene carbonate (VC); lactones such as γ-butyrolactone and γ-valerolactone; ethers such as trimethoxymethane, 1,2-dimethoxyethane, diethyl ether, 2-ethoxyethane, tetrahydrofuran, and 2-methyltetrahydrofuran; sulfoxides such as dimethyl sulfoxide; oxolanes such as 1,3-dioxolane, 4-methyl-1,3-dioxolane; nitrogen-containing compounds such as acetonitrile, nitromethane, formamide, and dimethylformamide; organic esters such as methyl formate, methyl acetate, ethyl acetate, butyl acetate, methyl propionate and ethyl propionate; phosphate triesters and diglymes; triglymes; sulfolanes such as sulfolane and methylsulfolane; oxazolidinones such as 3-methyl-2-oxazolidinone; sultones such as 1,3-propanesultone, 1,4-butanesultone and naphthasultone; and the like. These may be used singly or in a combination of two or more.

The solid electrolyte constituting the solid electrolyte layer is not particularly limited. When the bipolar battery of the present disclosure is a lithium ion secondary battery, for example, an inorganic solid electrolyte such as a sulfide-based solid electrolyte, an oxide-based solid electrolyte, or other lithium-based inorganic solid electrolyte; and an organic solid electrolyte such as a polymer electrolyte can be exemplified.

As the sulfide-based solid electrolyte, for example, Li₂S—P₂S₅, Li₂S—SiS₂, Li₂S—GeS₂, Li₂S—Al₂S₃, Li₂S—SiS₂—Li₃PO₄, Li₂S—P₂S₅—GeS₂, Li₂S—Li₂O—P₂S₅—SiS₂, Li₂S—GeS₂—P₂S₅—SiS₂, Li₂S—SnS₂—P₂S₅—SiS₂, and the like. These may be used singly or in a combination of two or more.

Examples of the oxide-based solid electrolyte include: NASICON types such as LiTi₂(PO₄)₃, LiZr₂(PO₄)₃, and LiGe₂(PO₄)₃; and perovskite types such as (La_{0.5+x}Li_{0.5-3x})TiO₃.

Other examples of the lithium-based inorganic solid-state electrolyte include LiPON, LiNbO₃, LiTaO₃, Li₃PO₄, LiPO₄₋ₓNₓ (where x is 0<x≤1), LiN, LiI, LISICON, and the like.

Further, glass ceramics obtained by depositing crystals of these inorganic solid electrolytes can also be used as the solid electrolyte.

As the organic solid electrolyte, for example, a polymer electrolyte such as a dry polymer electrolyte or a gel electrolyte can be used. As the polymer electrolyte, one generally used in a lithium ion secondary battery can be used.

The shape of the solid electrolyte may be, for example, particulate.

### Preparation of Current Collector for Bipolar Battery

### Lamination of Current Collectors

The copper foil as the first current collector and the aluminum foil as the second current collector were bonded to each other by using a dry laminator. More specifically, a conductive adhesive was applied to the aluminum foil so that the film thickness after drying was 3 μm, and the aluminum foil and the copper foil were bonded by hot roll pressing. As the conductive adhesive, an aqueous dispersion-based olefin-based resin (NZ-1015, manufactured by Toyobo MMC Co., Ltd.) in which nickel-plated particles were dispersed was used. Thus, the first current collector and the second current collector bonded to each other via the conductive adhesive layer were obtained. The conditions of the dry lamination were as follows:
Line-speed: 15 m/min
Gravure Roll: Elon Gate, 75-wire
Drying furnace temperature: 110° C.
Drying time: 40 seconds
Thermal roll temperature: 90° C.
Hot roll nip pressure: 0.4 MPa

### Welding of Current Collectors

The first current collector and the second current collector bonded to each other via the conductive adhesive layer were cut so as to have a rectangular planar shape, and welded by ultrasonic welding over the peripheral portion of the current collector to form a welded portion. The weld portion was formed to include the end of the current collector, and the weld portion was of the order of 5 mm. As a result, the current collector for a bipolar battery of the example was obtained.

### Comparative Example

A current collector for a bipolar battery of Comparative Example was obtained in the same manner as in Example except that welding of the current collector was not performed.

### EVALUATION

The obtained current collector for a bipolar battery was heated to 150° C., and the amount of water generated at that time was measured by a Karl Fischer moisture meter. When the water content of the current collector for a bipolar battery of the comparative example was 100, the water content of the current collector for a bipolar battery of the example was 5, and the water content of the current collector for a bipolar battery of the example was significantly smaller.

What is claimed is:

1. A current collector for a bipolar battery, wherein
a first current collector and a second current collector are bonded to each other via a conductive adhesive layer, and
a weld portion, in which the first current collector and the second current collector are welded to each other, is provided over a peripheral portion of the current collector for a bipolar battery, by which the conductive adhesive layer is sealed.

2. The current collector according to claim 1, wherein the conductive adhesive layer includes a water-based adhesive.

3. The current collector according to claim 1, wherein a width of the weld portion is no less than 1 mm and no more than 10 mm.

4. The current collector according to claim 1, further comprising a sealing member that seals the weld portion.

5. A bipolar battery comprising:
an anode active material layer;
the current collector according to claim 1; and
a cathode active material layer that are provided in an order of the anode active material layer, the current collector, and the cathode active material layer.
